(19) United States
(12) Patent Application Publication
(10) Pub. No.: US 2010/0245871 A1
(43) Pub. Date: Sep. 30, 2010

(54) METHOD OF CORRECTING PIXEL DATA AND FLUID EJECTING APPARATUS

(75) Inventors: Michiaki TOKUNAGA, Matsumoto-shi (JP); Masahiko YOSHIDA, Shiojiri-shi (JP); Takeshi YOSHIDA, Shiojiri-shi (JP); Tatsuya NAKANO, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/732,072

(22) Filed: Mar. 25, 2010

(30) Foreign Application Priority Data
Mar. 26, 2009 (JP) 2009-077327

(51) Int. Cl. H04N 1/60; B41J 29/38

(52) U.S. Cl. 358/1.9; 347/14

(57) ABSTRACT

A method for correcting pixel data and a fluid ejecting apparatus and are disclosed. The method for correcting pixel data in the fluid ejecting apparatus which relatively moves a nozzle array having nozzles for ejecting a fluid onto a medium and arranged in parallel in a predetermined direction, and the medium in a direction intersecting the predetermined direction, onto which the fluid is ejected from the nozzle array based on pixel data of the first number of gradations, while the nozzle array and the medium are relatively moved in the intersecting direction, the method includes converting original pixel data of the first number of gradations into pixel data of the second number of gradations higher than the first number of gradations; correcting the pixel data of the second number of gradations, of which the number of gradations is converted, by a correction value set for every pixel line data which is the plurality of pixel data lined up in a direction corresponding to the intersecting direction on the pixel data; and converting the pixel data of the second number of gradations which is corrected by the correction value into the pixel data of the first number of gradations.

### BACKGROUND

1. Technical Field

The present invention relates to a method of correcting pixel data and a fluid ejecting apparatus.

2. Related Art

As one kind of a fluid ejecting apparatus, there is known an ink jet printer (hereinafter, referred to as a printer) which performs printing by ejecting ink on various kinds of media, such as paper, fabric or film, from nozzles. Image data formed by a user is expressed by the high number of gradations. For this reason the data of the high number of gradations is half-tone processed by the printer driver to data of the low number gradations which can be formed by the printer. Then, the printer performs the printing based on the half-tone processed data.

In such a printer, there is a case in which, due to problems such as the working accuracy of the nozzles or like, ink droplets do not land on the medium at their proper positions, or variations in the quantity of ink ejection occurs, thereby causing unevenness in concentration. For example, in the case in which ink droplets fly on a skew from a certain nozzle, it exerts an effect upon not only concentration of an image section which is formed by the nozzle, but also concentration of an image section adjacent to the image section. Further, according to a printing method, the nozzle for forming the image section and a nozzle for forming an image section adjacent to the image section do not always correspond with each other. For this reason, it is not possible to suppress the concentration unevenness by correction values which are merely corresponded to the nozzles.

Accordingly, a method for calculating the correction values for every region (hereinafter, referred to as a line region) on the medium, on which the image section is formed, has been proposed (e.g., see JP-A-2007-1141). The correction value is a correction value for performing concentration correction processing with respect to data of the high number of gradations which is prior to the half-tone processing.

Although it is not limited such that the data which is subjected to the concentration correction processing and the half-tone processing by a printer driver is transmitted to the printer, there is a case in which data which is not subjected to the concentration correction processing but subjected to the half-tone processing by another application program is transmitted to the printer. Since the correction value for performing the concentration correction processing is used for data of a high number of gradations prior to half-tone processing, there is a problem in that it is not applied to data of low number of gradations after the half-tone processing.

### SUMMARY

An advantage of some aspects of the invention is that it corrects data after half-tone processing.

According to an embodiment of the invention, there is provided a method for correcting pixel data in a fluid ejecting apparatus which relatively moves a nozzle array having nozzles for ejecting a fluid onto a medium and arranged in parallel in a predetermined direction, and the medium in a direction intersecting the predetermined direction, in which the fluid is ejected from the nozzle array based on pixel data of the first number of gradations, while the nozzle array and the medium are relatively moved in the intersecting direction, the method including converting original pixel data of the first number of gradations into pixel data of the second number of gradations higher than the first number of gradations; correcting the pixel data of the second number of gradations, of which the number of gradations is converted, by a correction value set for every pixel line data which is the plurality of pixel data lined up in a direction corresponding to the intersecting direction on the pixel data; and converting the pixel data of the second number of gradations which is corrected by the correction value into the pixel data of the first number of gradations.

Other characteristics of the invention will be apparent from the description of the specification and the accompanying drawings.

### BRIEF DESCRIPTION OF THE DRAWINGS

The invention will be described with reference to the accompanying drawings, wherein like numbers reference like elements.

FIG. 1A is a block diagram showing the overall configuration of a printer, and FIG. 1B is a perspective view showing a portion of the printer.

FIG. 2 is a view showing a nozzle array on a bottom surface of a head.

FIG. 3A and FIG. 3B are explanatory views of common printing.

FIG. 4 is an explanatory view of leading-end printing and trailing-end printing.

FIG. 5A is an explanatory view showing a case in which dots are ideally formed, FIG. 5B is an explanatory view showing a case in which unevenness in concentration occurs, and FIG. 5C is an explanatory view showing a case in which dots are formed in accordance with correction values.

FIG. 6A is a view showing a test pattern, and FIG. 6B is a view showing a correction pattern.

FIG. 7 is a view showing the results read by a scanner with respect to a correction pattern of cyan.

FIG. 8A and FIG. 8B are views showing a method of calculating a correction value for the unevenness in concentration.

FIG. 9 is a view showing a correction value table.

FIG. 10 is a view showing a shape of calculating a correction value corresponding to each of gradation values.

FIG. 11A is a flowchart showing a concentration correction processing (printing process) of a comparative embodiment, and FIG. 11B is a flowchart showing a concentration correction processing (printing process) of the embodiment.

FIG. 12A is an explanatory view showing a table on a formation rate of dots, FIG. 12B is a view showing a shape of ON/OFF judgment of a dot by a dither method, and FIG. 12C is a view showing a shape of an error diffusion method.

FIG. 13 is a view showing conversion of pixel data according to Example 1.

FIG. 14 is a view showing a shape of converting original data of 4 gradations into a high gradation value.

FIG. 15 is a view showing a shape of averaging original data of 256 gradations.

FIG. 16 is a view showing a shape of determining a correction value.

FIG. 17A is a view showing pixel data prior to half-tone processing, and FIG. 17B is a view showing a difference of concentration unevenness correction values H.

FIG. 18A is a view showing a shape of averaging processing without weighting pixel data, and FIG. 18B is a view showing a shape of averaging each line region.

FIG. 19 is a view showing correction of original data of 256 gradations by a correction value.

FIG. 20 is a view showing conversion of pixel data according to Example 2.

FIG. 21 is a view showing conversion of pixel data according to Example 3.

### DESCRIPTION OF EXEMPLARY EMBODIMENTS

### Summary of Disclosure

The following points will be apparent from at least the specification and the accompanying drawings.

That is, there is provided a method for correcting pixel data in a fluid ejecting apparatus which relatively moves a nozzle array having nozzles for ejecting a fluid onto a medium and arranged in parallel in a predetermined direction, and the medium in a direction intersecting the predetermined direction, in which the fluid is ejected from the nozzle array based on pixel data of the first number of gradations, while the nozzle array and the medium are relatively moved in the intersecting direction, the method including converting original pixel data of the first number of gradations into pixel data of the second number of gradations higher than the first number of gradations; correcting the pixel data of the second number of gradations, of which the number of gradations is converted, by a correction value set for every pixel line data which is the plurality of pixel data lined up in a direction corresponding to the intersecting direction on the pixel data; and converting the pixel data of the second number of gradations which is corrected by the correction value into the pixel data of the first number of gradations.

With the correction method of the pixel data, it is possible to perform concentration unevenness correction with respect to the data which have been half-tone processed.

In the correction method of the pixel data, in the original pixel data of second number of gradations, of which the number of gradations is converted from the original pixel data of the first number of gradations, distributing a gradation value expressed by the selected original pixel data among the original pixel data of the second number of gradations to the selected original pixel data and the original pixel data adjacent to the selected original pixel data to calculate averaged pixel data of the second number of gradations; determining a correction value corresponding to the averaged pixel data of the second number of gradations; and correcting the original pixel data of the second number of gradations by the determined correction value.

With the correction method, it is possible to correct the original pixel data of the second number of gradations by the correction value close to the correction value corresponding to the pixel data of the second number of gradations expressed by the image data from the user. Further, in the pixel data converted to the first number of gradations, it is possible to convert the pixel data possibly equal to the original pixel data of the first number of gradations into pixel data which ejects the fluid.

In the correction method of the pixel data, in the original pixel data of second number of gradations, of which the number of gradations is converted from the original pixel data of the first number of gradations, distributing a gradation value expressed by the selected original pixel data among the original pixel data of the second number of gradations to the selected original pixel data and the original pixel data adjacent to the selected original pixel data to calculate averaged pixel data of the second number of gradations; determining a correction value corresponding to the averaged pixel data of the second number of gradations; and correcting the averaged pixel data of the second number of gradations by the determined correction value.

With the correction method of the pixel data, it is possible to correct the averaged pixel data of the second number of gradations by the correction value close to the correction value corresponding to the pixel data of the second number of gradations expressed by the image data from the user.

In the correction method of the pixel data, the correction value is set for a plurality of gradation values in the second number of gradations.

With the correction method of the pixel data, it is possible to correct the pixel data by the correction value according to the gradation value.

In the correction method of the pixel data, when the second gradation value expressed by the selected original pixel data is distributed to the selected original pixel data and the original pixel data adjacent to the selected original pixel data, the gradation values which are distributed to the original pixel data spaced apart from the selected original pixel data at first distance are more than the gradation values which are distributed to the original pixel data spaced apart from the original pixel data at a second distance which is longer than the first distance.

With the correction method of the pixel data, it is possible to average the pixel data by enlarging an effect of the selected pixel data as the pixel data is close to the selected pixel data.

In the correction method of the pixel data, the correction value corresponding to the original pixel data of the second number of gradations, of which the number of gradations is converted from the original pixel data of the first number of gradations, is determined, and the original pixel data of the second number of gradations is corrected by the determined correction value.

With the correction method of the pixel data, it is possible to shorten a correction time.

In the correction method of the pixel data, when the pixel data of the second number of gradations which is corrected by the correction value is converted into the pixel data of the first number of gradations, a value related to a formation rate of the dots corresponding to the gradation value expressed by the selected pixel data among the pixel data of the second number of gradations is compared with a threshold value to determine existence of dot formation in the selected pixel data; and a difference between the value related to the formation rate of the dots and the threshold value is distributed to the pixel data adjacent to the selected pixel data.

With the correction method of the pixel data, it is possible to reflect the correction of the pixel data by the correction value in the image.

Further, thee is provided a fluid ejecting apparatus including a nozzle array having nozzles for ejecting a fluid onto a medium and arranged in parallel in a predetermined direction, a moving mechanism relatively moving the nozzle array and the medium in a direction intersecting the predetermined direction, and a control unit that ejects the fluid from the nozzle array based on pixel data of the first number of gradations, while the nozzle array and the medium are relatively moved in the intersecting direction by the moving mechanism, wherein original pixel data of the first number of gradations is converted into pixel data of the second number of gradations higher than the first number of gradations; the pixel data of the second number of gradations, of which the number of gradations is converted, is corrected by a correction value set for every pixel line data which is the plurality of pixel data lined up in a direction corresponding to the intersecting direction on the pixel data; and the pixel data of the second number of gradations which is corrected by the correction value is converted into the pixel data of the first number of gradations.

With the fluid ejecting apparatus, it is possible to correct, for example, the unevenness in concentration with respect to the data which has been half-tone processed.

### Regarding the Printing System

A printing system will now be described with reference to an ink jet printer (hereinafter, referred to as a printer 1) serving as an example of a fluid ejecting apparatus, in which the printer 1 is connected to a computer 60.

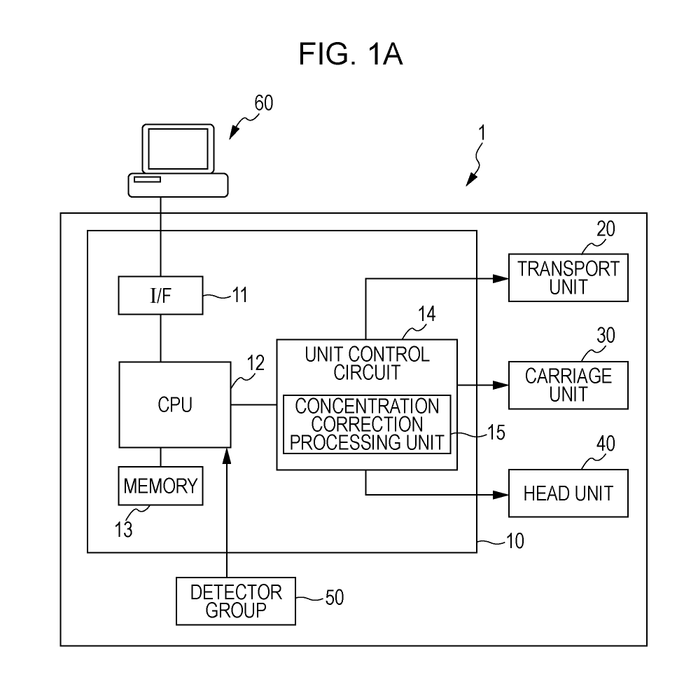

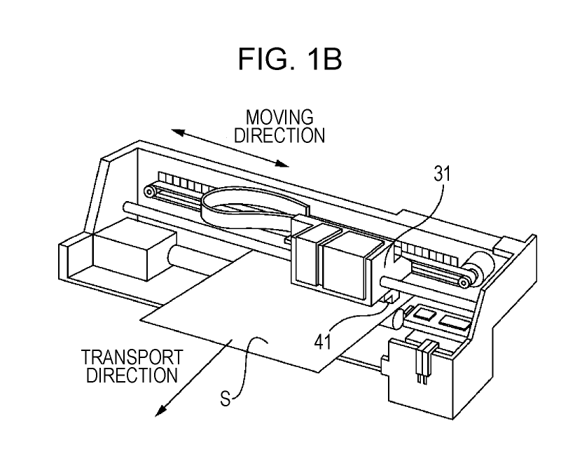

FIG. 1A is a block diagram showing the overall configuration of the printer 1, and FIG. 1B is a perspective view showing a portion of the printer 1. The printer 1 receiving print data from the computer 60 which is a peripheral device controls each unit (a transport unit 20, a carriage unit 30, and a head unit 40) by a controller 10 to form an image on paper S (a medium). Further, a detector group 50 detects an internal status of the printer 1, and the controller 10 controls each unit based on the detected results.

The controller 10 is a control unit for controlling the printer 1. An interface portion 11 is adapted to transmit and receive the data between the printer 1 and the computer 60 which is a peripheral device. A CPU 12 is an operation processing device for controlling the overall printer 1. A memory 13 is adapted to secure a working area and an area for storing programs of the CPU 12. The CPU 12 controls each unit by using a unit control circuit 14.

The transport unit 20 feeds the paper S to a printable position, and transports the paper S in a transport direction (corresponding to a determined direction) at a predetermined transport amount at the time of printing.

A carriage unit 30 (corresponding to a moving mechanism) is adapted to move a head 41 in a direction (hereinafter, referred to as a moving direction and corresponding to an intersecting direction) intersecting the transport direction.

The head unit 40 is adapted to eject the ink on the paper S, and has the head 41. The head 41 is provided on a bottom surface thereof with a plurality of nozzles which serve as an ink ejecting portion. The ink droplets are ejected from the nozzles by driving a piezoelectric element corresponding to the respective nozzles.

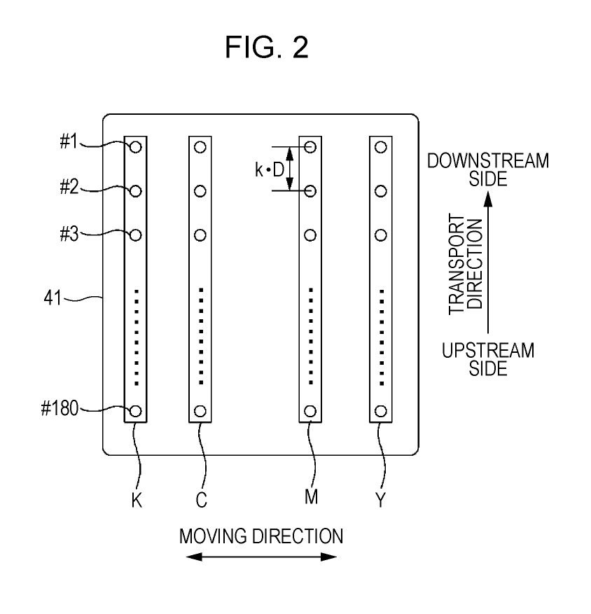

FIG. 2 is a view showing nozzle array on the bottom surface of the head 41. Nozzle lines are formed, in which 180 nozzles (#1 to #180) are arranged in parallel in the transport direction at a predetermined nozzle pitch k·D. The head 41 is provided four nozzle lines to eject the ink of different colors, respectively. The head 41 of this embodiment has a yellow nozzle line Y for ejecting yellow ink, a magenta nozzle line M for ejecting magenta ink, a cyan nozzle line C for ejecting cyan ink, and a black nozzle line K for ejecting black ink.

The serial printer 1 having such a configuration intermittently ejects the ink from the head 41 which is moved in the moving direction by the carriage unit 30 in response to printing data, thereby forming a dot line (a raster line) on the paper S along the moving direction. The dot formation operation and transport operation which transport the paper S in the transport direction by using the transport unit 20 are alternatively performed. As a result, it is possible to form the dots at positions different from the position of the dots which have been formed by the previous dot formation operation, thereby forming a 2D image on the paper.

### Regarding the Printing Data

The printing data transmitted from the computer 60 to the printer 1 is prepared by a printer driver stored in the memory of the computer 60. A brief overview of the preparation processing of the printing data will now be described.

First, at resolution conversion processing, image data output from various application programs is converted into resolution corresponding to the time in which it is printed on the paper S. The image data after the resolution conversion processing is RGB data of 256 gradations expressed by an RGB color space. In this instance, the image data are constituted by a plurality of pixel data.

Next, at color conversion processing, the RGB data are converted into CMYK data corresponding to the ink of the printer 1.

After that, at half-tone processing, the data of a high number of gradations, that is, 256 gradations, are converted into data of a low number of gradations which can be formed by the printer 1. The printer 1 of this embodiment converts the data of 4 gradations so as to form three kinds of dots.

Finally, at rasterizing processing, the image data of a matrix shape is rearranged for every data in the order of transmission to the printer 1.

The data which have been subjected to the above processing are transmitted to the printer 1 by the printer driver as the printing data together with command data according to a printing mode (transport amount or the like).

### Regarding Interlace Printing

The printer 1 of this embodiment generally performs interlace printing. In interlace printing, a raster line of other pass is formed between raster lines which are recorded at one pass. Since a printing method is generally different at the start and end of the printing, common printing, leading-end printing and trailing-end printing are respectively described.

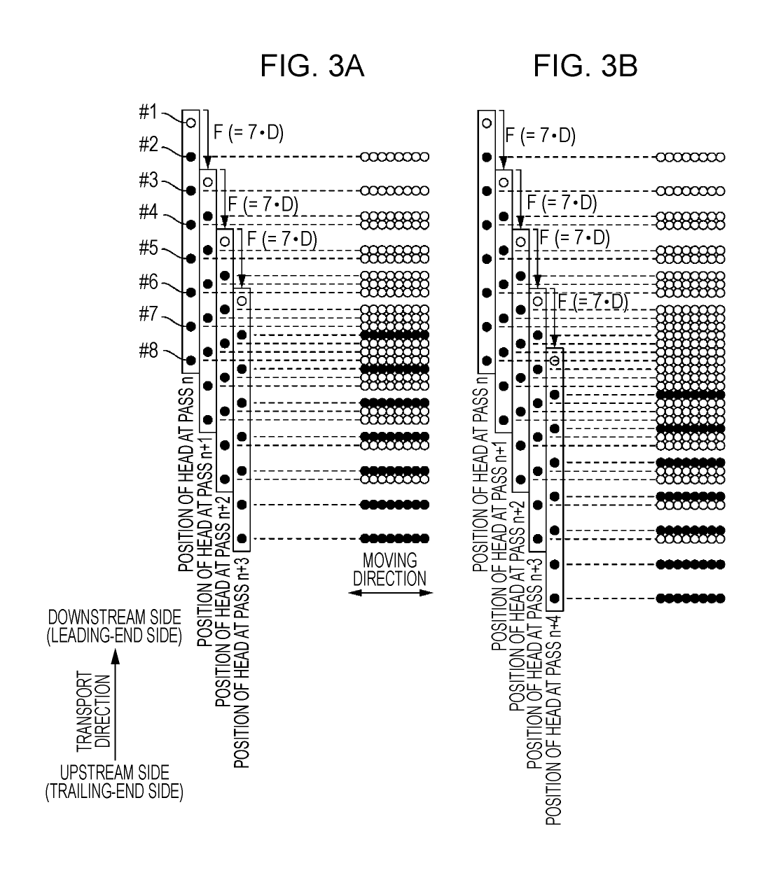

FIGS. 3A and 3B are explanatory views of the common printing. FIG. 3A shows a shape of n-th pass to (n+3)-th pass, and FIG. 3B shows a shape of n-th pass to (n+4)-th pass. For descriptive convenience, the number of the nozzle lines is reduced, and it is shown that the head 41 (the nozzle line) is moved with respect to the paper S, in order to express the relative position between the nozzle line and the paper S. In the figure, the nozzles expressed by black circles are ink ejection nozzles, and the nozzles expressed by white circles are ink non-ejection nozzles. Further, in the figure, the dots expressed by black circles are dots which are formed at a final pass, and the dots expressed by white circles are dots which are formed at the previous pass.

In the common printing of interlace printing, whenever the paper S is transported in the transport direction by a constant transport amount F, the respective nozzles records the raster line just above (at leading end side) the raster line which is recorded at the last pass. In order to perform the record in a constant transport amount, it is subject to the conditions in which the number N (integral number) of the nozzles which can eject the ink has to be in relatively prime relation with k (the nozzle pitch k·D) and the transport amount F has to be set by ND. Wherein, N=7, k=4, and F=7·D. However, in this way, at the start and end of the printing, there are portion in which the raster line is not formed. For this reason, at the leading-end printing and trailing-end printing, a printing method different from the common printing is performed.

FIG. 4 is an explanatory view of leading-end printing and trailing-end printing. Initial passes of 5 times are leading-end printing, and final passes of 5 times are trailing-end printing. At leading-end printing, the paper S is transported by the transport amount (1·D or 2·D) smaller than the transport amount (7·D) at the common printing. At leading-end printing and trailing-end printing, the nozzles ejecting the ink are not constant. Consequently, at the start and end of the printing, a plurality of raster lines which are continuously extended in parallel in the transport direction can be formed. Further, at leading-end printing, 30 raster lines are formed, and at trailing-end printing, 30 raster lines are formed. By contrast, at the common printing, approximately several thousands of raster lines are formed, which are varied depending upon the size of the paper S.

In a manner in which the raster lines are arranged in the region (hereinafter, referred to as a common printing region) printed by the common printing, there is the regularity every the same number of raster lines as that of the nozzles which can eject the ink (herein, N=7). The raster lines from the raster line which is initially formed at the common printing to 7^{th} raster line are formed by the nozzles #3, #5, #7, #2, #4, #6 and #8, and seven raster lines after the next 8^{th} raster line are formed the respective nozzles in the same order. It is difficult to find the regularity in the arrangement of the raster line in the region (hereinafter, referred to as a leading-end printing region) printed by leading-end printing, and in the region (hereinafter, referred to as a trailing-end printing region) printed by trailing-end printing, as compared with the raster line in the common printing region.

### Regarding the Unevenness in Concentration

For the purpose of the description below, a “pixel region” and a “line region” are set. The term “pixel region” means a rectangular region which is imaginarily set on the paper S, and the size thereof is determined by the print resolution. One “pixel region” on the paper S corresponds to one “pixel data” on the image data. Further, the term “line region” means a region formed by a plurality of pixel regions which are arranged in parallel in the moving direction. The “line region” corresponds to the “pixel line data” in which a plurality of pixel data on the image data is lined up in a direction corresponding to the moving direction.

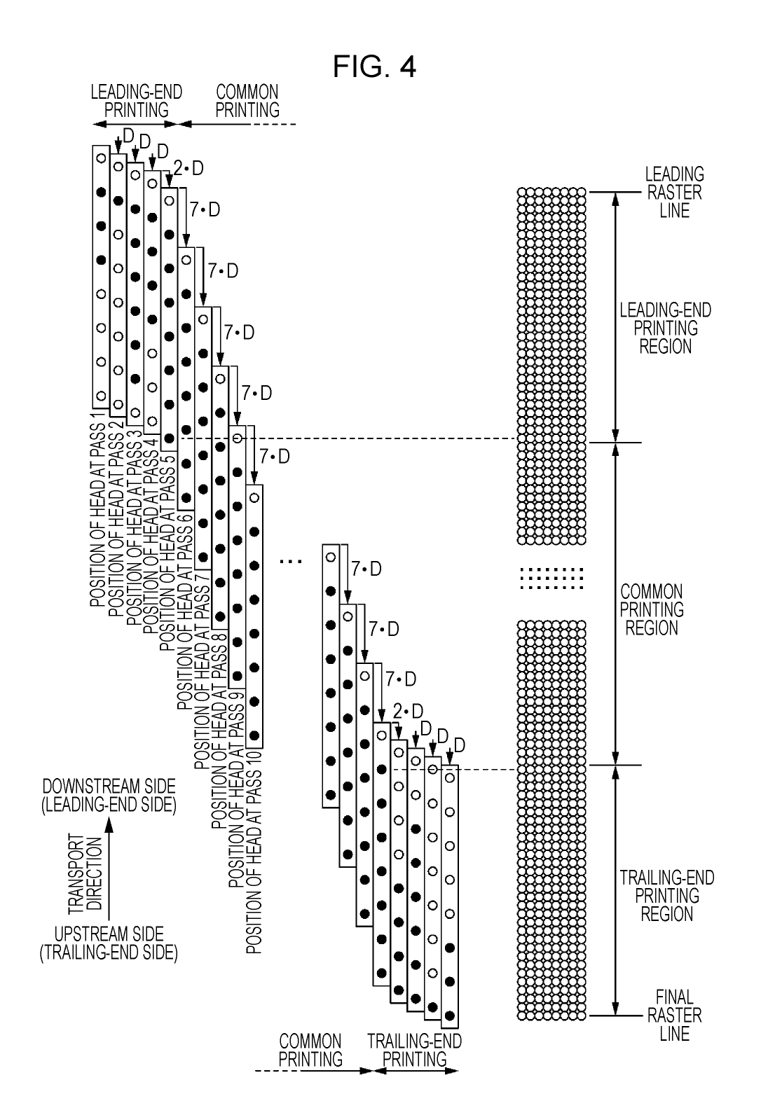

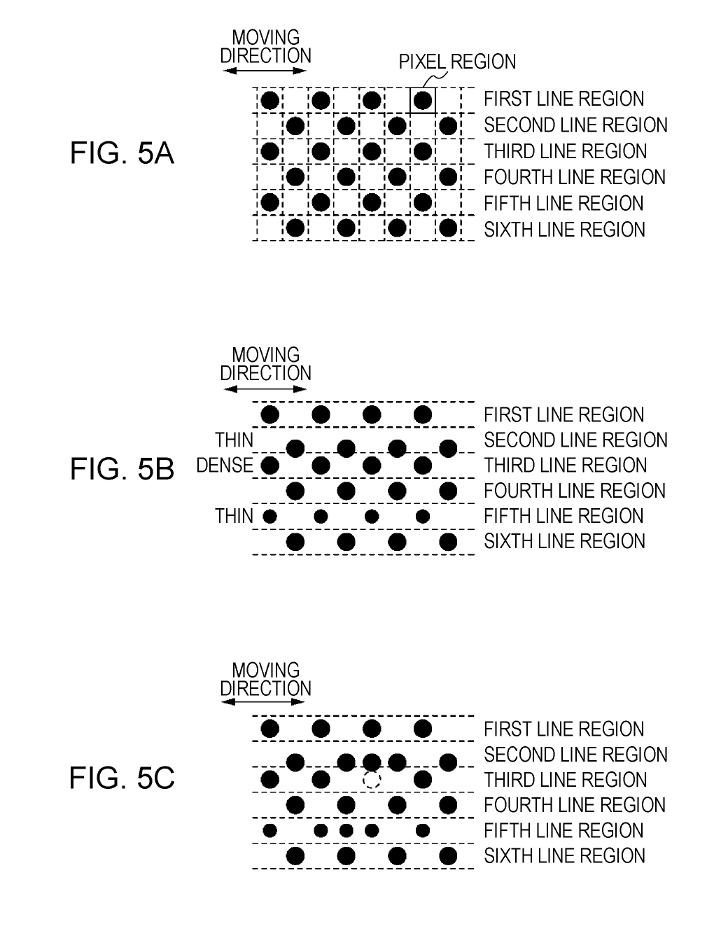

FIG. 5A is an explanatory view showing a case in which the dots are ideally formed. The fact in which the dots are ideally formed means that the ink droplets of specified amount are landed at a center portion of the pixel region to form the dots.

FIG. 5B is an explanatory view showing a case in which the unevenness in concentration occurs. The raster line formed in the second line region is formed under a bias towards the third line region side by the ink droplets ejected and flied on a skew from the nozzles. As a result, the second line region becomes thin, and the third line region becomes dense. Since the ink quantity of the ink droplets ejected in the fifth line region is smaller than a defined amount, the dots formed in the fifth line region become small. As a result, the fifth line region becomes thin. If the image constituted by arrays of different shading is macroscopically seen, the concentration unevenness of a stripped shape is visually recognized in the moving direction of the carriage.

FIG. 5C is an explanatory view showing a case in which the dots are formed in accordance with correction values (described below) used in this embodiment. In order to form thin image sections with respect to the line region which is easily visually recognized to be dense, the gradation value expressed by the pixel data corresponding to the line region is corrected. Further, in order to form dense image sections with respect to the line region which is easily visually recognized to be thin, the gradation value expressed by the pixel data corresponding to the line region is corrected. For example, as formation rates of the dots on the second and fifth line regions which are visually recognized to be dense are increased, a formation rate of the dots on the third line region which is visually recognized to be dense is lowered. In this way, it is possible to suppress the unevenness in concentration of the image.

Here, in FIG. 5B, the reason why the concentration of the image section formed in the third line region becomes dense is not by an influence of the nozzles which form the raster line in the third line region, but by an influence of the nozzles which form the raster line in the second neighboring line region. For this reason, in the case in which the nozzles forming the raster line in the third line region form the raster line in other line region, it is not always true that the image section formed in the line region becomes dense. In interlace printing shown in FIGS. 3 and 4, it is not always true that the line region adjacent to the line region allocated to a certain nozzles is the same nozzles every time.

That is, even in the image section formed by the same nozzles, there is a case in which the concentration is different, if the nozzles forming the neighboring image sections are different. In such a case, it is not possible to suppress the unevenness in concentration by the correction value merely corresponding to the nozzles. Consequently, the concentration unevenness correction value H is set for every line region (every pixel line data) in this embodiment.

### Regarding the Concentration Unevenness Correction Value H

Since the unevenness in concentration is caused by problems such as processing accuracy of the nozzles or like, the correction value H for every line region (every pixel line data) is calculated for every printer 1 at the time of fabrication of the printer 1 or the like. The printer 1 calculating the correction value H is connected to a scanner and a computer. The computer is installed with a printer driver for printing a test pattern (which will be described below) through the printer 1, and a correction value acquiring program for calculating the correction value H based on the reading data read by the scanner. The method of acquiring the correction value H will now be described.

### Printing of Test Pattern

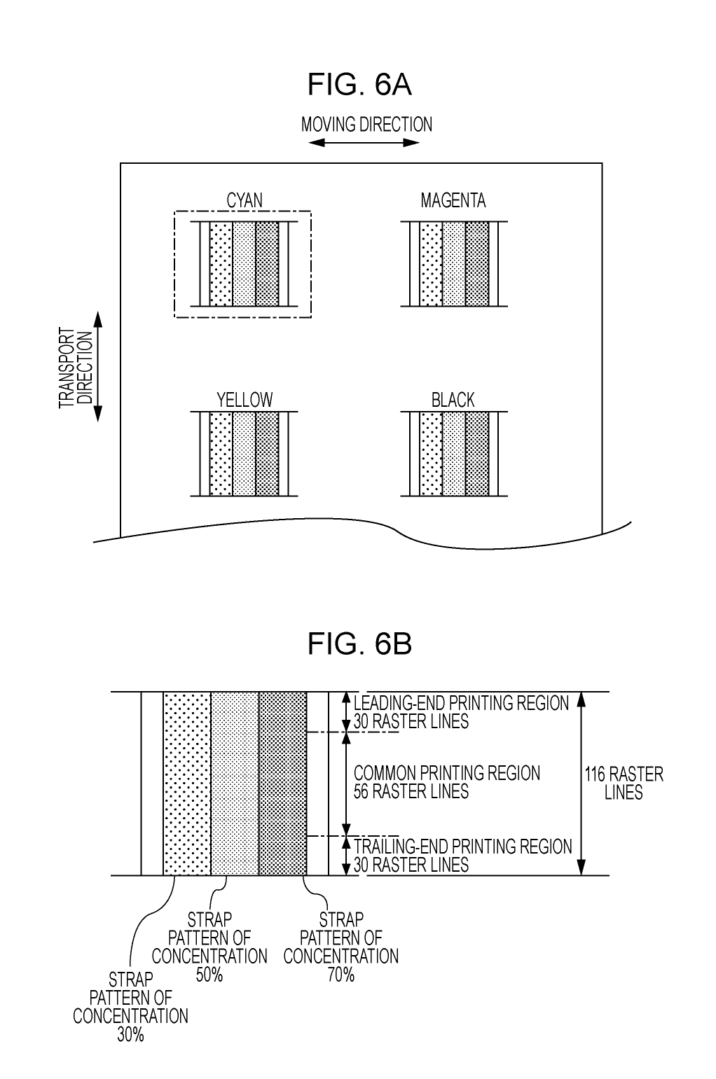

FIG. 6A is a view showing a test pattern, and FIG. 6B is a view showing a correction pattern. The test pattern is constituted by 4 correction patterns formed for every nozzle lines of different colors (cyan, magenta, yellow and black). The respective correction pattern is constituted by a strapped pattern having three kinds of concentration. Each of the respective strapped patterns is generated from the image data of constant gradation value. The gradation value for forming the strapped pattern is referred to as a command gradation value, in which a command gradation value of the strapped pattern of concentration 30% is expressed by Sa(76), a command gradation value of the strapped pattern of concentration 50% is expressed by Sb(128), and a command gradation value of the strapped pattern of concentration 70% is expressed by Sc(179). In this instance, the high gradation value indicates the dense concentration, and the low gradation value indicates the thin concentration.

Further, in interlace printing described above, the respective strapped pattern is constituted by 30 raster lines formed by leading-end printing, 56 raster lines formed by the common printing, and 30 raster lines formed by trailing-end printing. In other words, the strapped pattern is formed by 116 line regions in total.

### Acquisition of Read Gradation Value

Next, the read gradation values for every color and concentration are acquired by reading the test pattern with the scanner. Further, one pixel line data (a plurality of pixel data lined up in a direction corresponding to the moving direction) in the data read by the scanner corresponds to one line region (one raster line) in the correction pattern.

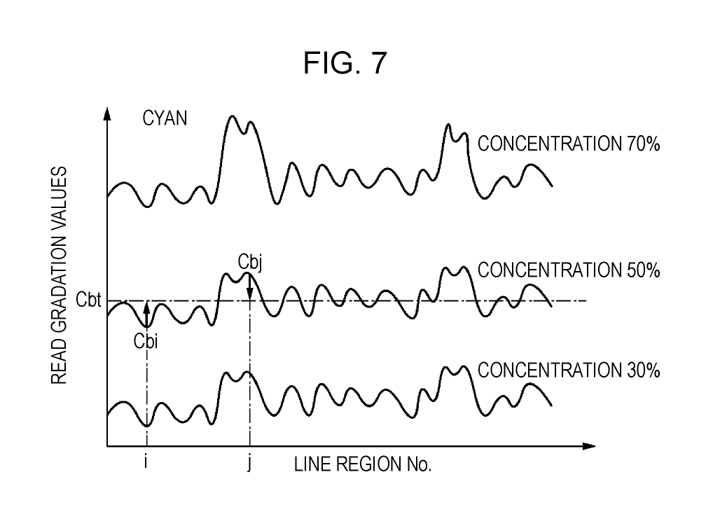

FIG. 7 is the result in which the cyan correction pattern is read by the scanner. The read data of cyan will now be described by way of example. After the pixel line data and the line region (the raster line) are corresponded one-to-one to each other, the concentration of the respective line regions is calculated for every strapped pattern. An average value of the read gradation values of the respective pixel data belonging to the pixel line data which corresponds one-to-one to a certain line region is set as the read gradation value of the line region. In the graph of FIG. 7, a transverse axis is referred to as a line region number, and a vertical axis is referred to as a read gradation value of the respective region.

Irrespective of the respective strapped patterns which is uniformly formed by each of the command gradation values, as shown in FIG. 7, a variation occurs in the read gradation values for every line region. For example, in the graph in FIG. 7, the read gradation value Cbi of the i-th line region is lower than the read gradation value of other line region, and the read gradation value Cbj of the j-th line region is higher the read gradation value of the other line region. That is, the i-th line region is visually recognized to be thin, and the j-th line region is visually recognized to be dense. The variation in the read gradation values of the respective line region is the unevenness in concentration of the print image.

### Calculation of Concentration Unevenness Correction Value H

In order to improve the unevenness in concentration, the variation in the read gradation value for every line region is reduced. That is, the read gradation value of the respective line region is maintained in a constant value. Consequently, in the same command gradation value (e.g., Sb·concentration 50%), an average value Cbt of the read gradation value (Cb1 to Cb116) of the whole line region is set as a “target value Cbt”. In order to approach the read gradation value of the respective line region to the target value Cbt in the command gradation value Sb, the gradation value expressed by the pixel line data corresponding to the respective line region is corrected.

More specifically, in FIG. 7, the gradation value expressed by the pixel line data corresponding to the i-th line region having the read gradation value lower than the target value Cbt is corrected as a gradation value which is denser than the command gradation value Sb. Meanwhile, the gradation value expressed by the pixel line data corresponding to the j-th line region having the read gradation value higher than the target value Cbt is corrected as a gradation value which is thinner than the command gradation value Sb. In this way, in order to approach the concentration of the whole line region to a constant value for the same gradation value, a correction value H for correcting the gradation value of the pixel line data corresponding to the respective line region is calculated.

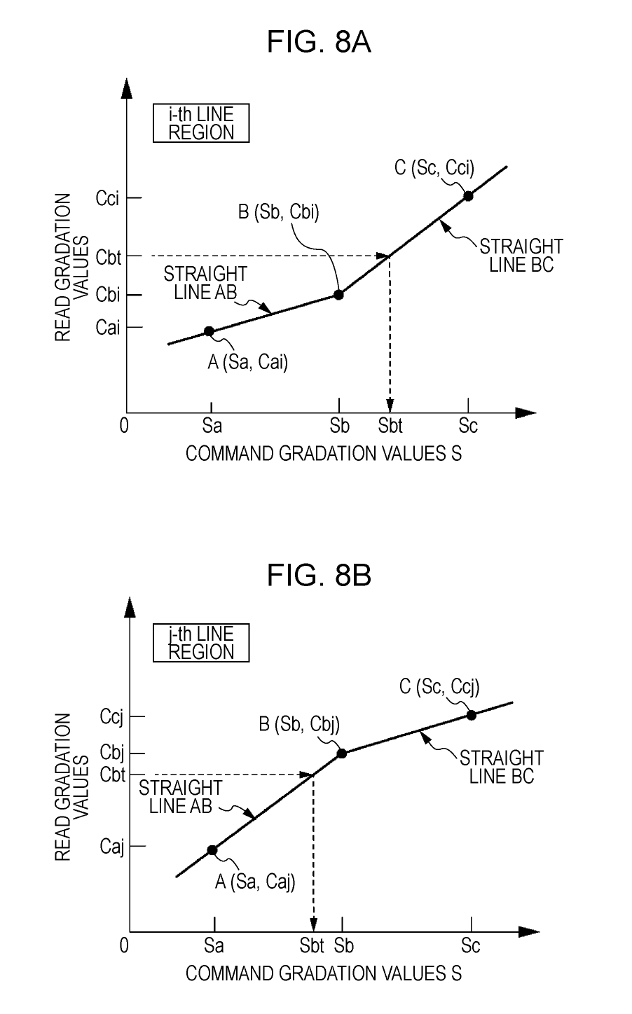

FIGS. 8A and 8B are views showing a concrete method for calculating the concentration unevenness correction value H. First, FIG. 8A shows the aspect in which the target command gradation value (e.g., Sbt) in the command gradation value (e.g., Sb) is calculated in the i-th line region having the read gradation value lower than the target value Cbt. A transverse axis indicates a gradation value, and a vertical axis indicates a read gradation value in the test pattern result. On the graph, the read gradation values (Cai, Cbi, and Cci) for the command gradation values (Sa, Sb, and Sc) are plotted. For example, the target command gradation value Sbt to express the i-th line region for the command gradation value Sb as the target value Cbt is calculated by the following equation (linear interpolation based on a straight line BC).

Sbt=Sb+{(Sc−Sb)×(Cbt−Cbi)/(Cci−Cbi)}

Similarly, as shown in FIG. 8B, in the j-th line region having the read gradation value higher than the target value Cbt, the target command gradation value Sbt to express the j-th line region for the command gradation value Sb as the target value Cbt is calculated by the following equation (linear interpolation based on a straight line AB).

Sbt=Sa+{(Sb−Sa)×(Cbt−Caj)/(Cbi−Caj)}

In this way, the target command gradation value Sbt of the respective line regions for the command gradation value Sb is calculated. Thus, the cyan correction value Hb for the command gradation value Sb of the respective line regions is calculated by the following equation. Similarly, the correction values for other command gradation values (Sa and Sc) and the correction values for other colors (yellow, magenta and black) are calculated.

Hb=(Sbt−Sb)/Sb

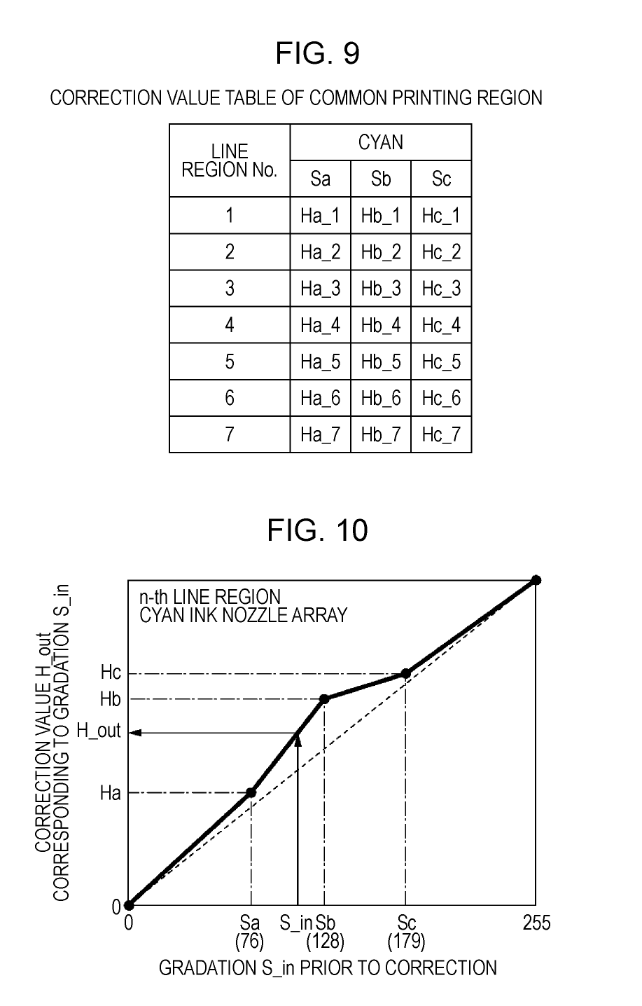

FIG. 9 is a view showing a correction value table for cyan of the common printing region in interlace printing. As described above, since there is the regularity for every 7 raster lines in the common printing region, 7 correction values for every command gradation value (Sa, Sb and Sc) in the common printing region is calculated. For example, the correction value for the command gradation value Sa of the first line region having the regularity is expressed as “Ha_{—}1”. In this instance, since 56 raster lines are printed on the common printing region in the correction pattern (FIG. 6B), the correction value H may be calculated based on the average value of the read gradation value of 8 line regions in total at intervals of 7 line regions.

Such correction value tables are prepared for leading-end printing region and the trailing-end printing region (not shown). Further, each correction value tables is prepared for the common printing region, the leading-end printing region and the trailing-end printing region other color in case of other colors (yellow, magenta and black). In this way, the test pattern for calculating the correction value H is stored in the memory 13 of the printer 1. After that, the printer 1 is shipped to a user.

### Regarding the Concentration Correction Processing According to a Comparative Embodiment

A user installs the printer driver in the computer 60 connected to the printer 1 at the start time of using the printer 1. If then, the printer driver requests the printer 1 to transmit the correction value H stored in the memory 13 to the computer 60. The printer driver stores the correction value H transmitted from the printer 1 in the memory of the computer 60.

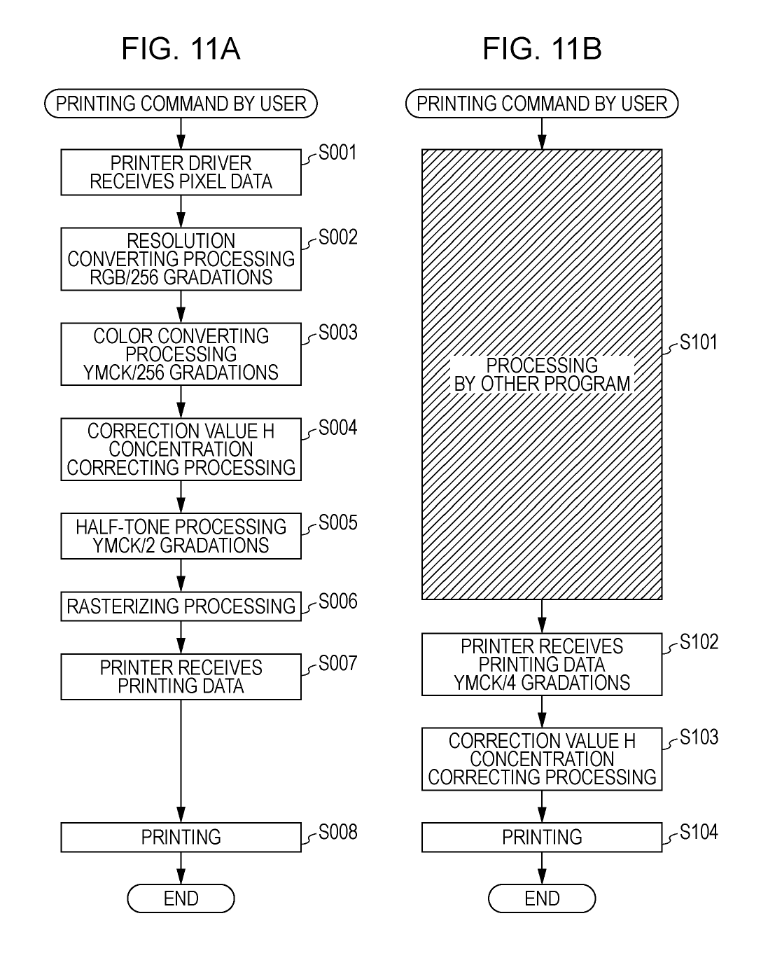

FIG. 10 is a view showing a shape of calculating the correction value H corresponding to the respective gradation values for the n-th line region of cyan. A transverse axis indicates a gradation value S_in prior to the correction, and a vertical axis indicates a correction value H_out corresponding to the gradation value S_in prior to the correction. FIG. 11A is a flowchart showing the concentration correction processing (printing processing) according to the comparative embodiment. As described above, if the printer driver receives a printing command from the user, it generates printing data in accordance with the flowchart in FIG. 11A, and transmits the printing data to the printer 1.

First, the printer driver receives the image data from various kinds of application software, as well as the printing command of the user (S001). The image data are converted into the resolution corresponding to the printing resolution (S002), and the color conversion is performed in accordance with colors YMCK of the ink provided in the printer 1 (S003).

The printer driver performs the concentration correction processing with respect to the data of 256 gradations of YMCK by using the correction value H (S004). That is, the gradation value (the gradation value S_in prior to the correction) of 256 gradations of each pixel data constituting the image data is corrected by the correction value H set for every color and line region corresponding to the pixel data.

If the gradation value S_in prior to the correction is equal to any one Sa, Sb, or Sc of the command gradation values, the correction values Ha, Hb and Hc stored in the memory of the computer 60 as the correction value H corresponding to the respective command gradation values can be used intact. For example, if the gradation value S_in prior to the correction is Sc, the gradation value S_out after the correction is obtained by the following equation.

S_out=Sc×(1+Hc)

If the gradation value S_in prior to the correction is different from the command gradation value, the correction value H_out according to the gradation value S_in prior to the correction is calculated. For example, as shown in FIG. 10, if the gradation value S_in prior to the correction is between the command gradation values Sa and Sb, the correction value H_out is calculated by the following equation according to the linear interpolation of the correction value Ha of the command gradation value Sa and the correction value Hb of the command gradation value Sb, and then the gradation value S_out after the correction is calculated.

H_out=Ha+{(Hb−Ha)×(S_in−Sa)/(Sb−Sa)}

S_out=S_in×(1+H_out)

In this instance, if the gradation value S_in prior to the correction is smaller than the command gradation value Sa, the correction value H_out is calculated by the linear interpolation of the minimum gradation value 0 and the command gradation value Sa, and if the gradation value S_in prior to the correction is larger than the command gradation value Sc, the correction value H_out is calculated by the linear interpolation of the maximum gradation value 255 and the command gradation value Sc.

In this way, the gradation value S_in expressed by pixel data of 256 gradations is corrected by the correction value H set for every color, line region corresponding to the pixel data and the gradation value. And thus, the gradation value S_in of the pixel data corresponding to the line region, of which the concentration is visually recognized to be thin, is corrected as the dense gradation value S_out, and the gradation value S_in of the pixel data corresponding to the line region, of which the concentration is visually recognized to be dense, is corrected as the thin gradation value S_out. As a result, it is possible to reduce the unevenness in concentration occurring in the printed image.

The printer driver converts the pixel data (S_out) of 256 gradations after the correction into the pixel data of 4 gradations according to the kind of the dots which can be formed by the printer 1, by the half-tone processing (S005 in FIG. 11A). The printer 1 of this embodiment can form 3 kinds of dots (large dots, middle dots and small dots), and the 8-bit data of 256 gradations is converted into 2-bit data of 4 gradations by the half-tone processing. For example, the pixel data expressing “large dot formation” is converted into “11”, the pixel data expressing “middle dot formation” is converted into “10”, the pixel data expressing “small dot formation” is converted into “01”, and the pixel data expressing “no dot exists” is converted into “00”. Next, the concrete method of the half-tone processing will be described.

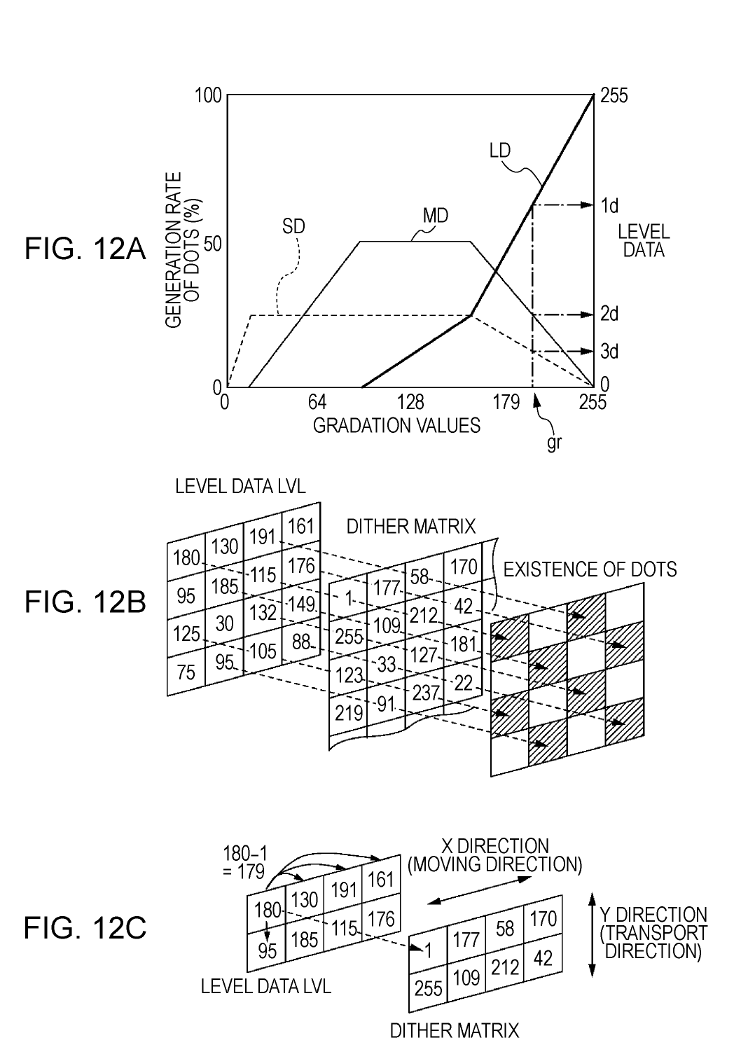

FIG. 12A is an explanatory view of a table on the formation rate of the dots. A transverse axis of a graph indicates gradation values (0 to 255), and a vertical axis indicates a generation rate of the dot (0 to 100%) at a left side thereof and indicates a level data at a right side thereof. FIG. 12B is a view showing a shape of ON/OFF judgment of the dot by a dither method. FIG. 12C is a view showing a shape of an error diffusion method.

The term “generation rate of the dot” means, when the same regions are reproduced according to the constant gradation value, a ratio of a pixel forming a dot among the pixels in the region. For example, in the case in which the gradation value of all the pixel data of 16×16 pixels is a constant value, when n dots are formed in the 16×16 pixels, the formation rate of the dots in the gradation value is expressed by {n/(16×16)}×100(%)}. A profile SD indicated by a dotted line in the figure expresses the formation rate of the small dots, a profile MD indicated by a thin solid line in the figure expresses the formation rate of the middle dots, and a profile LD indicated by a thick solid line in the figure expresses the formation rate of the large dots. Further, the term “level data” means data of which the formation rate of the dots is expressed by 256 steps of 0 to 255 values.

First, the printer driver sets large-dot level data in accordance with the gradation value of certain pixel data. For example, if the gradation value of certain pixel data is gr shown in the figure, the large-dot level data are set as 1d based on the profile LD. It is judged whether the large-dot level data are larger than a threshold value set to each pixel of a dither matrix shown in FIG. 12B. The threshold value is set as different values for each pixel of the dither matrix. In this embodiment, a matrix in which the 16×16 pixel blocks are expressed by values of 0 to 255 is used.

For example, for the pixel on the left side of FIG. 12B, the large-dot level data are set as “180”. The threshold value on the dither matrix corresponding to the pixel is “1”. The printer driver compares the large-dot level data “180” with the threshold value “1”. In this instance, it is judged that the large-dot level data are larger than the threshold value, and the pixel data of the pixel on the left side is converted into “11 (formation of large dots)”, and then the processing of the pixel data is completed. In FIG. 12B, the pixels, in which the dots are formed, are indicated by an oblique line.

Meanwhile, if the large-dot level data are equal to or less than the threshold value, the printer driver sets middle-dot level data. In the pixel data of a gradation value gr, the middle-dot level data are set as 2d based on the profile MD. If the middle-dot level data are larger than the threshold value, the pixel data of the pixel is converted into “10 (formation of middle dots)”, and then the processing of the pixel data is completed. In this instance, the threshold value of the dither matrix is set for every kind of the dot.

Then, if the middle-dot level data are equal to or less than the threshold value, it is judged whether the small-dot level data are larger than the threshold value or not. If the small-dot level data are larger than the threshold value, the pixel data of the pixel is converted into “01 (formation of small dots)”, and if the small-dot level data are equal to or less than the threshold value, the pixel data of the pixel is converted into “00 (no dot exists)”. Then, the processing of the pixel data is completed. In this way, the pixel data of 256 gradations is converted into pixel data of 4 gradations.

Further, at the time of half-tone processing, as shown in FIG. 12C, the embodiment applies the error diffusion method. In the error diffusion method, a difference (error) between the level data of the pixel which judges the existence of the dot formation and the threshold value corresponding to the pixel is distributed (diffused) to the non-processed pixel. In the non-processed pixel which is distributed with the error, the total value of the level data of the pixel and the error is compared with the threshold value corresponding to the dither matrix to judge the existence of the dot formation.

For example, in FIG. 12C, the printer driver compares the level data of the pixel on the left side with the threshold value of the dither matrix, and judges that the dots are formed on the pixel on the left side. After the judgment, the printer driver calculates the error “179(=180−1)” between the level data (corresponding to a value related to a formation rate of dots) and the threshold value. The error is distributed to the pixels arranged in parallel with the pixel on the left side in the X direction or the pixels arranged in parallel with the pixel on the left side in the Y direction. In this instance, in the case in which the threshold value is larger than the level data, minus error is distributed to the neighboring pixel. In this way, it is possible to reduce the local concentration error, thereby smoothing the concentration of the whole image.

In particular, it is preferable that the error diffusion method is performed in the case in which the gradation value is corrected by the correction value H. A correction amount in which the gradation value of each pixel data is increased or decreased by the correction value H is minute. For example, in order to make the line region dense, even though the gradation value of the pixel data belonging to the line region is increased by the correction value H and thus the value of the level data is increased, there is a situation that the number of the dots or the size of the dot is not increased in accordance with the threshold value of the dither matrix. For this reason, the value of the level data is highly corrected by correcting highly the gradation value of a certain pixel, but, even though the dot is not formed in the pixel by the relationship of the threshold value, since the error of the threshold value and the level data is distributed to the neighboring pixels, new dots are formed in any one of the non-processed pixels in the course of integrating the error. Therefore, the line region can be densely printed. By contrast, in the case in which the gradation value of a certain pixel is lowly corrected, a dot may be not formed in a certain pixel by distributing the minus error just as much as the corrected amount to the pixel.

For this reason, in order to reflect the error (the error between the level data and the threshold value) by the gradation value, which is increased or decreased by the correction value H, on the pixel belonging to the same line region, the error of certain pixel data may be distributed not to the pixel data which are lined up with the pixel data in the Y direction (corresponding to the transport direction), but to the pixel data which are lined-up with the pixel data in the X direction (corresponding to the moving direction), that is, the pixel data belonging to the same line region. For example, in FIG. 12C, the error “179” of the pixel on the left side is distributed to three pixel data belonging to the same line region, and one pixel data lined up in the Y direction. Further, when the error is distributed to the non-processed pixel, the error may be uniformly distributed to the pixels, or may be largely distributed to the pixel as the pixel is closer to the pixel in which the error occurs, by changing a weight. As such, according to the half-tone processing by the error diffusion method, the generation rate of the dots can be surely changed based on the correction value H, thereby solving the unevenness in concentration.

The pixel data of the low number of gradations which is half-tone processed is subjected to rasterizing processing (S006), as shown in FIG. 11A, and then is transmitted to the printer 1 as the printing data, together with command data. If the printer 1 receives the printing data (S007), the printing is performed on the basis of the printing data (S008).

Summarizing the above, in the concentration correction processing of the comparative embodiment, in the printing system in which the computer 60 installed with the printer driver is connected to the printer 1, the printer driver corrects the pixel data (the gradation value) of the high number of gradations (256 gradations) prior to the half-tone processing according to the correction value H, and then performs the half-tone processing, so that the corrected pixel data of the high number of gradations is converted into the pixel data of the low number of gradations (4 gradations).

Regarding the Concentration Correction Processing According to this Embodiment

FIG. 11B is a flowchart showing the concentration correction processing (printing process) of this embodiment. In the concentration correction processing of the comparative embodiment, the printer driver corrects the pixel data prior to the half-tone processing according to the correction value H. However, it is not limited such that the printing data are transmitted to the printer 1 by the printer driver corresponding to the printer 1, and there is a case in which the printing data which is half-tone processed is transmitted to the printer 1 by application programs different from the printer driver (e.g., a program of a product manufactured by other company which is referred to as other program).

Similar to the printer driver, in other programs, in step S101 (a block portion indicated by an oblique line) in FIG. 11B, the image data formed by the user is subjected to the resolution conversion and the color conversion in line with the printing resolution, and then is half-tone processed. The printer drive obtains the correction value H from the memory 13 of the printer 1, corrects the pixel data of 256 gradations according to the correction value H, and then performs the half-tone processing. However, in other program, the pixel data of 256 gradations is not corrected, but is half-tone processed. That is, the printing data transmitted to the printer 1 from other program different from the printer driver is pixel data of 4 gradations which is not subjected to the concentration correction processing.

If the printer 1 performs the printing by using the printing data intact which is transmitted from other program, the concentration unevenness occurs in the printed image. Meanwhile, even though the concentration unevenness correction is performed with respect to the printing data transmitted from other program to improve the concentration unevenness, the correction value H stored in the memory 13 of the printer 1 is a correction value H corresponding to the pixel data of 256 gradations, and thus is not applied to the pixel data of 4 gradations which has been half-tone processed, as it is.

For this reason, an object of this embodiment is to perform the concentration correction processing with respect to the pixel data (the original pixel data) of low number of gradations (corresponding to 4 gradations; first number of gradations) by using the concentration unevenness correction values H corresponding to the pixel data of the high number of gradations (corresponding to 256 gradations; second number of gradations). Next, the concentration correction processing (S103 in FIG. 11B) for the pixel data of 4 gradations which has been half-tone processed will be described.

When the printer 1 receives the printing data, it judges whether the printing data are transmitted from the printer driver or from other program. In the case in which it is judged that the transmitted printing data is the printing data (the printing data which is subjected to the concentration correction processing by the correction value H) transmitted from the printer driver, the printer 1 performs the printing based the printing data (S008 in FIG. 11A). Meanwhile, in the case in which it is judged that the transmitted printing data is the printing data (the printing data which is not subjected to the concentration correction processing by the correction value H) transmitted from other program, the printer 1 corrects the printing data by the correction value H (S103 in FIG. 11B), and then performs the printing (S104).

### Concentration Correction Processing

### Example 1

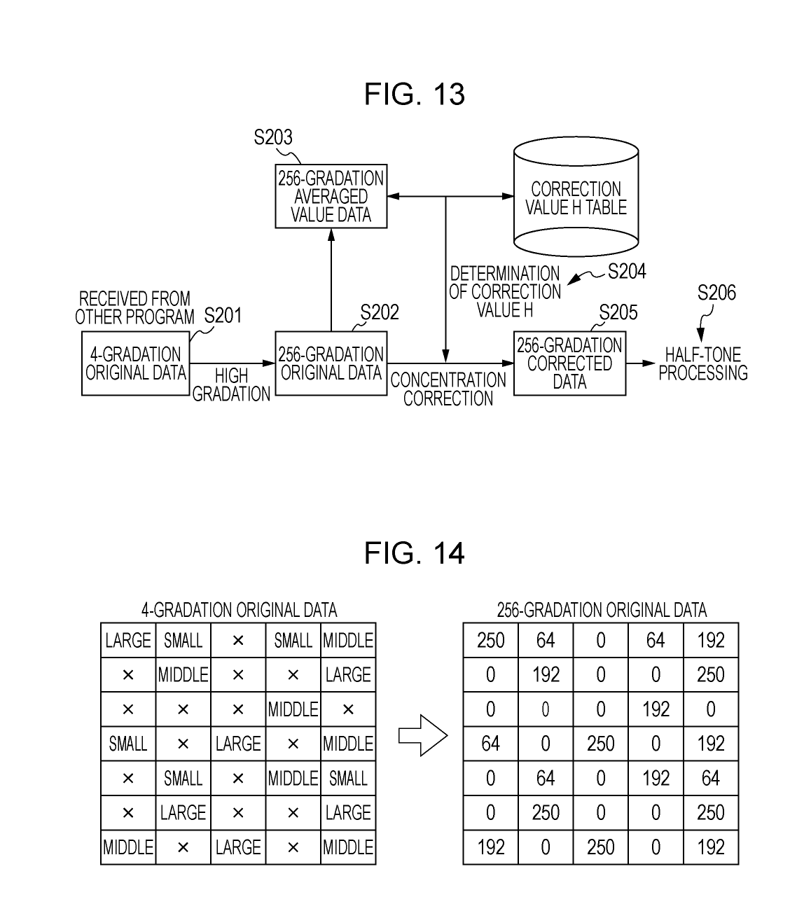

FIG. 13 is a view showing conversion of the pixel data in the concentration correction processing according to Example 1. The printing data transmitted from other program is subjected to the concentration correction processing by the concentration correction processing unit 15 (FIG. 1) in the controller 10 of the printer 1. If the concentration correction processing unit 15 receives the printing data from other program (S201 in FIG. 13), the data of 4 gradations (hereinafter, referred to as original data of 4 gradations) which has been half-tone processed is converted into data of 256 gradations (hereinafter, corresponding to original data of 256 gradations; original pixel data of second number of gradations) so as to correspond to the number of gradations of the correction value H (S202).

FIG. 14 is a view showing a shape of converting original data of 4 gradations into original data of 256 gradations by a high gradation value. In the figure, one space is referred to as pixel data. In the pixel data according to the original data of 4 gradations, a pixel forming a large dot is indicated as “large”, a pixel forming a middle dot is indicated as “middle”, and a pixel forming a small dot is indicated as “small”. A pixel forming no dot is indicated as “x”. In order to convert the pixel data of 4 gradations into high gradation, data of 256 gradations are pseudolly allocated to each data of 4 gradations.

Here, the pixel data forming large dots is converted into “gradation value 250”, the pixel data forming middle dots is converted into “gradation value 192”, the pixel data forming small dots is converted into “gradation value 64”, and the pixel data forming no dot is converted into “gradation value 0”. In this way, as shown in FIG. 14, the original data of 4 gradations may be inverted into original data of 256 gradations.

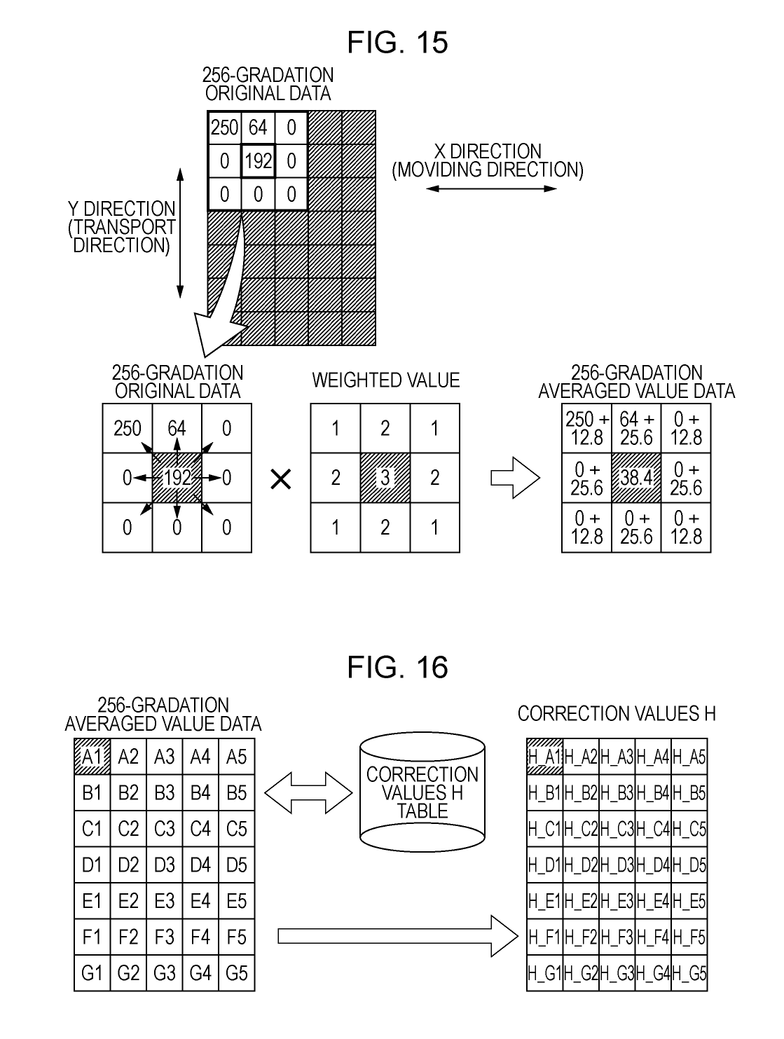

FIG. 15 is a view showing a shape of averaging the original data of 256 gradations for every unit region. In Example 1, the concentration correction processing unit 15 performs the averaging processing to the original pixel data of 256 gradations of which is converted into a high gradation value (S203 in FIG. 13). Here, a unit region of an averaging range is 3×3 pixels, but the size of the unit region is not limited thereto. In the original data of 256 gradations in FIG. 15, paying attention to a pixel (a pixel of 192 gradations) at a 2^{nd} position from a left side and a 2^{nd} position from an upper side, the averaging will be described. The selected pixel and 8 pixels adjacent (neighboring) to the selected pixel correspond to the unit region, and the gradation values (192) expressed by the selected pixel are averaged at the selected pixel and the 8 neighboring pixels. That is, the gradation values (192) expressed by the selected pixel are distributed to the selected pixel and the 8 neighboring pixels.

In this instance, in order to distribute a high gradation value of the selected pixel as the pixel is close to the selected pixel, a weighted value at the time of averaging is determined. For example, the weighted value is determined as “3” so that the most gradation values are distributed to the selected pixel itself. Among the 8 neighboring pixels, weighted values of two pixels which are arranged in parallel with the selected pixel in X direction (direction corresponding to the moving direction on data) and two pixels which are arranged in parallel with the selected pixel in Y direction (direction corresponding to the transport direction on data) are determined as “2”. Since the neighboring pixel (a pixel spaced apart from the selected pixel at the second distance) positioned in an oblique direction of the selected pixel is farther apart from the selected pixel than the neighboring pixel (a pixel spaced apart from the selected pixel at the first distance) arranged in parallel with the selected pixel in XY direction, the weighted value is determined as “1”.

In this way, the gradation values 192 of the selected pixel are distributed to the selected pixel and the neighboring pixels according to the weighted value. More specifically, “gradation values 38.4 (=192×3/15)” are distributed to the gradation value of the selected pixel, “gradation values 25.6 (=192×2/15)” are distributed to the neighboring pixels which are arranged in parallel with the selected pixel in the XY direction, and “gradation values 12.8 (=192/15)” are distributed to the neighboring pixels which are arranged in parallel with the selected pixel in an oblique direction. By taking all pixels as the selected pixel in the order from the upper left pixel in the XY direction in the original data of 256 gradations which is converted into high gradation, the gradation values of the selected pixel are averaged for every unit region (3×3 pixels). The data by averaging the 256 gradation original data of the selected pixel is referred to as averaged value data (corresponding to averaged pixel data of the second number of gradations) of 256 gradations. In the averaged value data of 256 gradations, the correction value expressed by each pixel data is the total of the gradation values of the remaining gradation values of the pixel data which are distributed to the neighboring pixel, and the gradation values distributed from the neighboring pixel.

FIG. 16 is a view showing a shape of determining the correction value H from the correction value H table and the averaged value data of 256 gradations. After calculating the averaged value data of 256 gradations, the concentration correction processing unit 15 determines the correction value H according to the gradation value expressed by each pixel data of the averaged value data of 256 gradations by referring to the correction value table (FIG. 9) stored in the memory 13 (S204 in FIG. 13). For example, since the gradation value expressed by the left upper pixel is “A1” in the averaged value data of 256 gradations, the concentration correction processing unit 15 obtains a correction value H_A1 corresponding to the gradation value A1 based on the correction value H table.

In this instance, the concentration correction processing unit 15 determines the correction value H in consideration of the color of the gradation value A1 among YMCK data or the position of the line region corresponding to the upper left pixel, as well as the gradation value A1. Further, if the gradation value A1 of the upper left pixel is equal to the command gradation values (Sa, Sb and Sc) used when the correction value H is calculated, the correction value H stored in the gradation value H table is used as it is. Meanwhile, if the gradation value A1 of the upper left pixel is different from the command gradation values, the concentration correction processing unit 15 calculates a correction value H_A1 corresponding to the gradation value A1 by linear interpolation, as shown in FIG. 10.

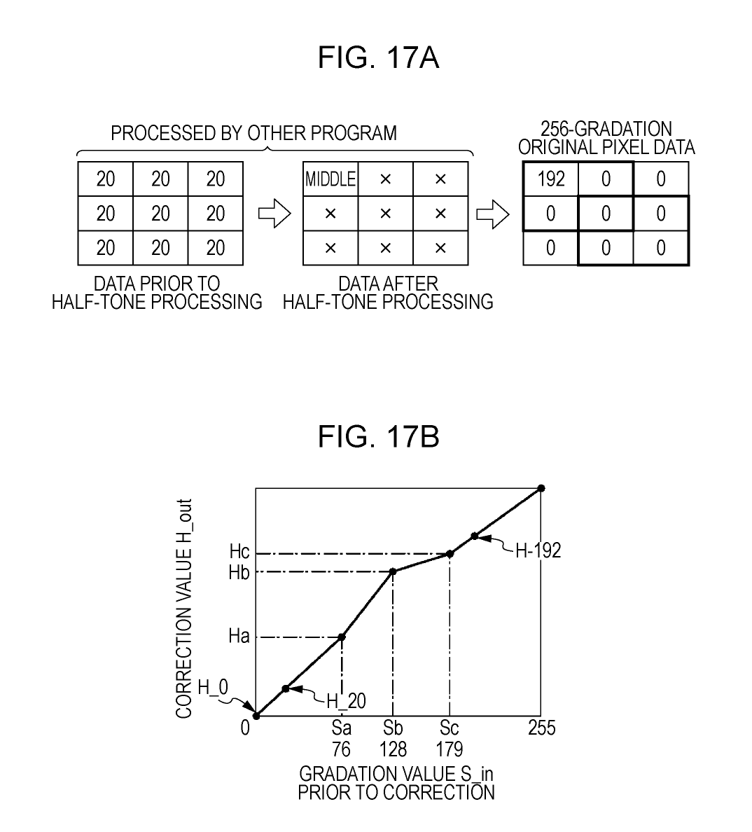

FIG. 17A is a view showing the pixel data before is half-tone processed by other program, and FIG. 17B is a view showing a difference of the concentration unevenness correction values H by whether the pixel data which is converted into high gradation is averaged or not. Here, the reason why the concentration unevenness correction values H is not determined based on the original pixel data (FIG. 14) of 256 gradations of which high gradation is pseudolly converted from the original pixel data of 4 gradations which has been half-tone processed, but the concentration unevenness correction values H is determined based on the averaged value data (FIG. 16) of 256 gradations which is averaged from the original pixel data of 256 gradations will be described, similar to the printer driver.

For example, as shown in FIG. 17A, suppose that in the pixel data of high gradation (256 gradations) prior to the half-tone processing, all the gradation values expressed by the pixel belonging to the unit region (the 3×3 pixels in the figure) are 20. And, suppose that as a result of the half-tone processing, a dot is formed in one of 9 pixels belonging to the unit region. Even though all pixels belonging to the unit region have the same gradation value 20, the dots do not always formed so as to be equal to all pixels. In order to be visually recognized as concentration of the gradation value 20 over the whole unit region when the unit region is macroscopically seen, the dots are formed by the half-tone processing.

However, the concentration unevenness correction values H (FIG. 9) stored in the memory 13 of the printer 1 is set with respect to three gradation values Sa, Sb and Sc, and the correction value H corresponding to each gradation values (0 to 255) of 256 gradations is calculated by the linear interpolation. As shown in FIG. 17B, in the printer 1 of this embodiment, as the gradation value is increased, the correction value H is increased. That is, in the case in which a dense image is printed, since the gradation value S_in prior to the correction is corrected by high correction value H, the correction extent is large. By contrast, in the case in which a thin image is printed, since the gradation value S_in prior to the correction is corrected by low correction value H, the correction extent is small. Therefore, it is possible to suppress the unevenness in concentration in line with the concentration of the image.

All the gradation value of the pixel data prior to the half-tone processing shown in FIG. 17A is 20. For this reason, similar to the concentration correction processing (FIG. 11A) in the comparative embodiment, in the case in which the concentration correction is performed with respect to the pixel data prior to the half-tone processing by the printer driver, relatively low correction value H_{—}20 corresponding to the gradation value 20 is used. In the concentration correction processing of this embodiment, the concentration correction has to be performed with respect to the pixel data which is half-tone processed once by other program. Accordingly, the concentration correction processing unit 15 converts pseudolly the original data of 4 gradations into the original data of 256 gradations, calculates the averaged value data of 256 gradations, and determines the correction value H based on the averaged value data of 256 gradations.

Here, suppose that the original data of 256 gradations is not averaged, but the correction value H is determined based on the original data of 256 gradations. For example, since the pixel, in which the middle dot is formed, of the pixel data which have been half-tone processed in FIG. 17A are substituted by “gradation value 192” at the high gradation, the correction value corresponding to the pixel is determined as “H_{—}192” which is a relatively high correction value. However, in fact, the gradation value expressed by the pixel is “20”, and the correction value H_{—}20 which has to be used to correct the gradation value of the pixel is a relatively small correction value. Further, inversely, since the pixel, in which the dot is not formed, of the pixel data which have been half-tone processed are substituted by “gradation value 0” at the high gradation, the correction value H corresponding to the pixel becomes H_{—}0 (=0), irrespective of that the correction value which has to correspond to the pixel is H_{—}20. In this case, since the gradation value S_out after the correction is calculated by “S_out=S_in×(1+H_out)”, the gradation value S_out after the correction is equal to the gradation value S_in prior to the correction.

That is, since the dots are formed at a predetermined probability in accordance with the concentration by the half-tone processing in the pixel data of the unit region, if the correction values H is determined based on the original pixel data of 256 gradations of which high gradation is pseudolly converted from the original pixel data of 4 gradations which has been half-tone processed, the correction value H corresponding to the gradation value higher than the gradation value expressed prior to the half-tone processing is determined in the pixel data in which the dots is formed. By contrast, there may be a case in which the correction value H corresponding to the gradation value lower than the calculation value prior to the half-tone processing is determined in the pixel data in which the dot is not formed. As a result, it is not possible for the printer 1 to use a proper correction value H, irrespective of whether the correction value H is set depending upon the gradation value (concentration).

Accordingly, in this embodiment, after the original pixel data of 4 gradations which has been half-tone processed is substituted by the original pixel data of 256 gradations, the original pixel data of 256 gradations is averaged for each unit region. As a result, the original pixel data of 4 gradations which has been half-tone processed may be restored to the original pixel data (gradation value) of 256 gradations prior to the half-tone processing as close as possible. Since the correction value H is determined based on the average value data of 256 gradations, the correction value H which possibly approximates to the correction value H corresponding to the pixel data of 256 gradations prior to the half-tone processing may be determined.

Further, it is preferable that the unit region (3×3 pixels in FIG. 15) is determined to have a proper size when the original pixel data of 256 gradations (FIG. 17A) is averaged. For example, supposes that the unit region is set by a size of 2×2 pixels which is smaller than 3×3 pixels, when the original pixel data of 256 gradations is averaged. So, when upper left 4 pixel data (the range enclosed by a thick line) is averaged, since the pixel in which a middle dot is formed is included, the averaged gradation value of the pixel is relatively increased. Inversely, when lower right 4 pixel data are averaged, since the pixel in which a dot is formed is not included, the averaged gradation value of the pixel becomes zero.

That is, if the unit region is set by too small at the time of averaging, since the dot is discretely formed by the pixel data of low gradation value, in the unit region including the pixel in which the dot is formed, the gradation value expressed by the pixel data after averaging is excessively increased as compared with the gradation value prior to the half-tone processing, or in the unit region not including the pixel in which the dot is formed, the gradation value expressed by the pixel data after averaging is excessively lowered as compared with the gradation value prior to the half-tone processing, so that the proper correction value H may not be determined.

Meanwhile, if the unit region is excessively enlarged, the gradation values are averaged together with many neighboring pixels, irrespective of that dots are intensively formed in an edge portion (outline portion) of the image. In this way, the correction value H corresponding to the edge portion of the image is determined by the correction value H of low gradation value, so that the effect of the unevenness in concentration may be reduced. That is, by setting the unit region in a proper size, when the pixel data which have been half-tone processed are restored to the pixel data of high gradation, it may approximate to the pixel data (gradation value) of high gradation prior to the half-tone processing, thereby determining the correction value H corresponding to proper concentration.

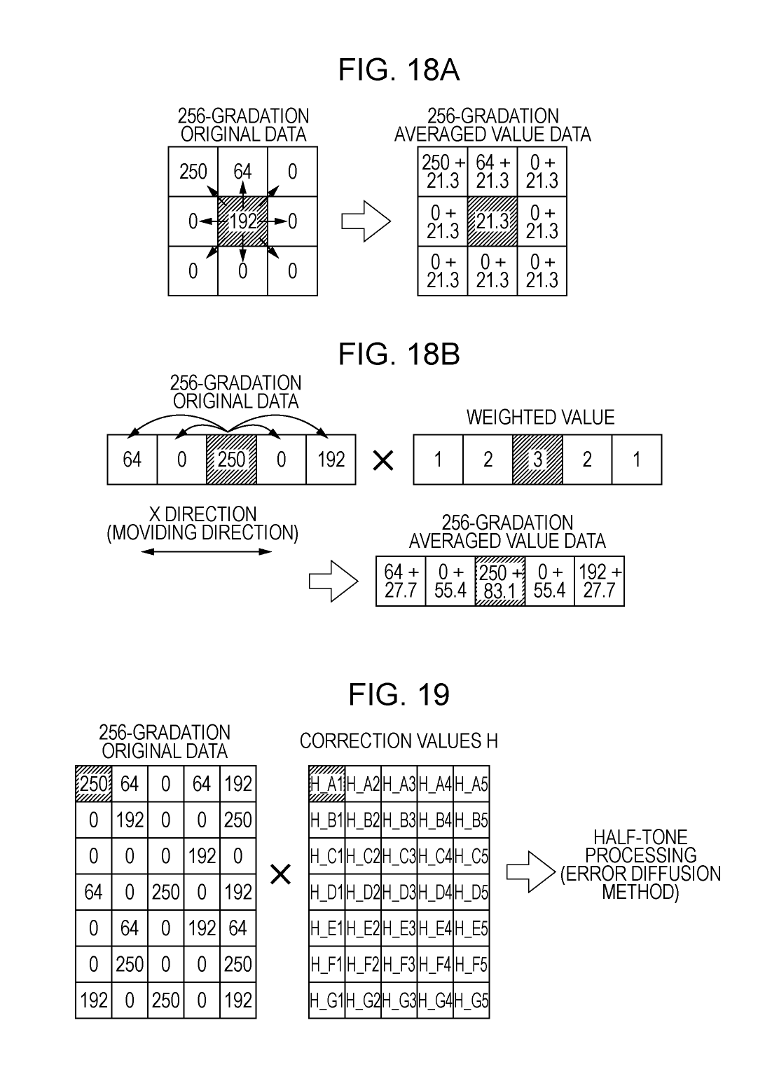

FIG. 18A is a view showing a shape of averaging processing of the original pixel data of 256 gradations without weighting the pixel data. In FIG. 15, a high gradation value of the selected pixel is distributed to the selected pixel itself and the pixels which are more close to the selected pixel, but it is not limited thereto. The gradation value of the selected pixel may be evenly distributed to the selected pixel itself and the neighboring pixels. For example, in FIG. 18A, since the gradation value expressed by the selected pixel (the pixel indicated by an oblique line) is 192 and the pixels belonging to the unit region are 9, the gradation values 21.3 (=192/9) are distributed to each pixel.

FIG. 18B is a view showing a shape of averaging the original pixel data of 256 gradations for every pixel line data corresponding to the line region. Although the image data on the matrix is described by way of an example, it is not limited thereto. There is a case in which the printer 1 is transmitted with data of a matrix shape or the printer 1 is transmitted with pixel line data in the order for every line region corresponding to each nozzle. For this reason, if the printing data transmitted to the printer 1 is pixel line data, the pixels arranged in parallel with the selected pixel in left and right directions along the X direction (direction corresponding to the moving direction on the data) may be averaged. For example, in FIG. 18B, a gradation value 250 of the selected pixel is distributed to two pixel arranged in parallel with the selected pixel in the X direction. In this instance, as shown in the figures, the value may be higher as the neighboring pixels closer to the selected pixel is weighted, or the gradation value may be uniformly distributed.

FIG. 19 is a view showing correction of the original data of 256 gradations by the determined correction value H. Next, the concentration correction processing unit 15 corrects not the averaged data of 256 gradations, but the original data of 256 gradations by using the correction value H determined on basis of the averaged data of 256 gradations (S205 in FIG. 13). For example, the gradation value expressed by the upper left pixel in the original data of 256 gradations in FIG. 19 is “250”. The correction value corresponding to the upper left pixel is “H-A1”. For this reason, the gradation value 250 of the upper left pixel is corrected as the post-correction gradation value S_out by the following equation.

S_out=250×(1+H_{—}A1)

In this way, the gradation value is corrected with respect to the pixel data belonging to other original data of 256 gradations by the corresponding correction value H (S205 in FIG. 13). The correction data S_out of high gradation (256 gradations) corrected by the concentration unevenness correction values H is again half-tone processed (S206 in FIG. 13).

In this instance, as shown in FIG. 14 of this embodiment, when the original data of 4 gradations is converted into high gradation, the gradation value of the pixel data, in which no dot is formed, is substituted by “0”. For this reason, even though the gradation value 0 is multiplied by the correction value H, the gradation value S_out after the correction is zero. Accordingly, the correction value H of the pixel data, in which no dot is formed, may not be determined. However, when the original data of 4 gradations is converted into high gradation, in the case in which the gradation value of the pixel data, in which no dot is formed, is substituted by “1” or more, the correction value H of the pixel data, in which no dot is formed, is necessarily determined.

In Example 1, the concentration correction processing unit 15 corrects the gradation value of the pixel data constituting the original data of 256 gradations by the correction value H determined on the basis of the averaged data of 256 gradations. The reason is that it is to form the dots possibly at the same position (or near position) as the original data of 4 gradations which is half-tone processed by other program. There are many cases in which the half-tone processing method using other program is different from the half-tone processing which is performed by the concentration correction processing unit 15 of the printer 1. For this reason, even though the averaged value data of 256 gradations is close to the gradation value of the pixel data prior to the half-tone processing, it does not means it is completely restored. Therefore, if the half-tone processing is performed based on the averaged value data of 256 gradations, the dots are formed at position spaced apart from the dot positions by the original data of 4 gradations which is half-tone processed by other program, so that the image may be slightly deviated from an image to be printed by the user. In particular, if the dots are formed at positions shifted from an edge portion (the outline) of the image, the image may become faint.

For this reason, in Example 1, the concentration correction processing unit 15 corrects the original data of 256 gradations by the correction value H, and then performs the half-tone processing with respect to the corrected pixel data. As a result, since the gradation value of the pixel data, in which the dot is formed, in the printing data formed by other program is increased, when the half-tone processing is performed as shown in FIG. 12, the level data of the pixel data, in which the dot is formed, is increased. If the level data of the pixel data are increased, a threshold value of a dither matrix is increased, so that the dots are easily formed. And thus, similar to the image by the printing data of other program, it is possible to print the image without becoming faint at the edge portion or the like, and the image of which the unevenness in concentration is reduced as compared with the image by the printing data of other program can be printed. In this instance, similar to the half-tone processing by the printer driver, the concentration correction processing unit 15 may perform the error diffusion (FIG. 12C) at the time of the half-tone processing. Therefore, the formation rate of the dots can be changed depending upon the correction value H, the unevenness in concentration may be solved more and more.

In this way, the pixel data which is half-tone processed by another program different from the printer drive is converted to the high gradation, the concentration correction is performed by using the correction value H corresponding to the 256 gradations, and then the printer 1 performs the printing according to the printing data which is half-toned processed again (S104 in FIG. 11B).

Summarizing the above, in Example 1, the concentration correction processing unit 15 converts the pixel data which have been half-tone processed from other program into high gradation to calculate the original data of 256 gradations, and determines the correction value H corresponding to the averaged value data of 256 gradations which is averaged from the original data of 256 gradations. As a result, the concentration correction can be performed by the correction value H close to the correction value H corresponding to the gradation value expressed by the pixel data prior to the half-tone processing by other program. The original data of 256 gradations is corrected by the correction value H determined by the above way and then is half-tone processed, so that the dots can be formed possibly at the same position (or near position) as the positions of the dots formed by the image data which have been half-tone processed by other program, thereby preventing deviation of the image (the edge portion becomes faint).

In this instance, the above processing (FIG. 13) is performed by the concentration correction processing unit 15 in the controller 10 of the printer 1, the controller 10 corresponds to a control unit, and the printer 1 corresponds to the fluid ejecting apparatus. The invention is not limited thereto, and the above processing may be performed by the printer driver. That is, in the case in which the printer 1 receives the printing data from other program, the printer 1 transmits the printing data to the printer driver, the printer drivers performs the processing of FIG. 13, and the printing data are returned to the printer 1. In this instance, the computer 60 installed with the printer drive and the controller 10 of the printer 1 correspond to a control unit, and the printing system connected to the printer 1 and the computer 60 corresponds to the fluid ejecting apparatus.

### Concentration Correction Processing

### Example 2

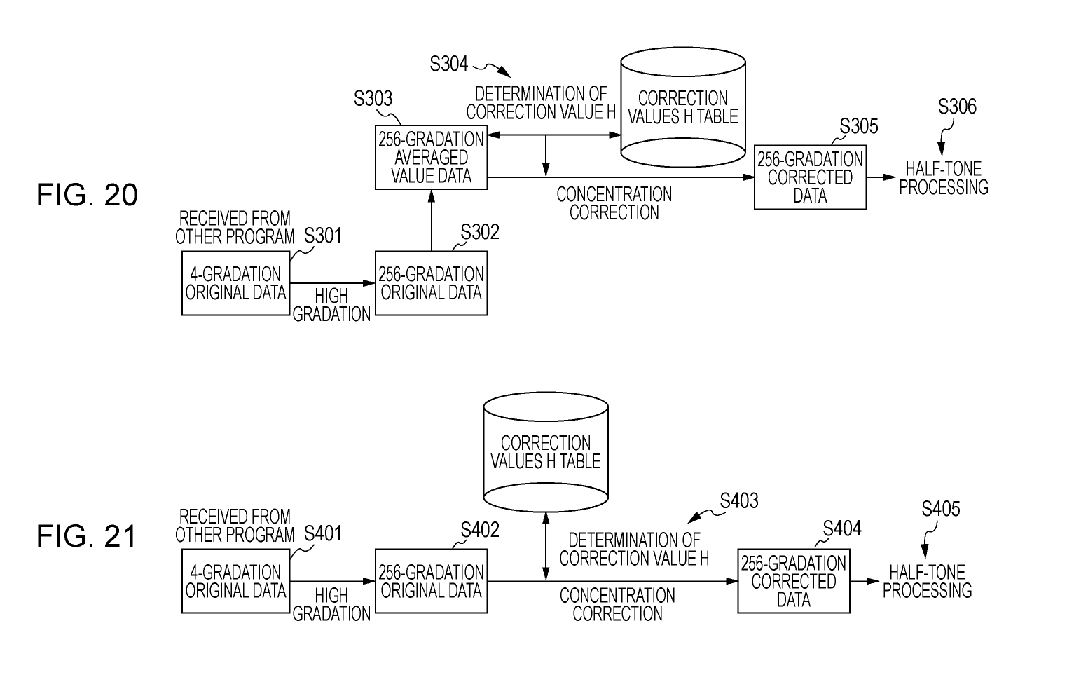

FIG. 20 is a view showing conversion of the pixel data in the concentration correction processing according to Example 2. In Example 1, after the correction value H is determined on the basis of the averaged value data of 256 gradations, the original data of 256 gradations is corrected by the correction value H. It is not limited thereto, and as Example 2, after the correction value H is determined on the basis of the averaged value data of 256 gradations, the averaged value data of 256 gradations may be corrected by the correction value H, and the half-tone processing may be performed.

As a result, the concentration correction can be performed by the correction value H corresponding to the data close to the pixel data of 256 gradations prior to the half-tone processing by other program. Similar to Example 1, the dots, of which the original data of 256 gradations is corrected by the correction value H and then is half-tone processed, can be formed possibly at the same position as the positions of the dots formed by the data which have been half-tone processed by other program, thereby preventing deviation of the image (the edge portion becoming blurred).

### Concentration Correction Processing

### Example 3

FIG. 21 is a view showing conversion of the pixel data in the concentration correction processing according to Example 3. In Example 1 and Example 2, the correction value H is determined on the basis of the averaged value data of 256 gradations. It is not limited thereto, and as Example 3, after the correction value H is determined on the basis of the original data of 256 gradations, the averaged value data of 256 gradations may be corrected by the correction value H, and the half-tone processing may be performed. As a result, as compared with Example 1 or Example 2, the time of concentration correction processing can be shortened by not calculating the averaged value data of 256 gradations. However, similar to Example 1 or Example 2, the correction value H determined on the basis of the averaged value data of 256 gradations may be determined as the correction value H close to the correction value H corresponding to the gradation value expressed by the pixel data prior to the half-tone processing by other program.

Inversely, if the printer has the correction values H which are not set in detail for every gradation value, similar to the printer 1 of this embodiment, it is possible to shorten the time of concentration correction processing by applying Example 3.

### Other Embodiments

While the printing system including an ink jet printer is described in each of the embodiments, the disclosure of the method for correcting the concentration unevenness is included. The embodiments are intended not to definitively interpret the invention but to facilitate comprehension thereof. It is apparent to those skilled in the art that the invention can be modified and varied, without deviating from its teachings, and includes its equivalents. In particular, the embodiments described below are contained in the invention.

### Regarding Other Printers

In the above-described embodiment, the serial printer repeating the operation in which the head 41 moves in a direction intersecting the nozzle line to form the image and the operation in which the medium is transported in a nozzle line direction is given by an illustration, but it is not limited thereto. For example, it can be applied to a line printer having nozzles extended in parallel in the moving direction across a width of paper, in which the medium is continuously transported under the extended nozzle lines. In addition, the invention may be applied to a printer which forms an image by repeatedly performing an operation in which a head moves in a transport direction of a continuous sheet with respect to the continuous sheet transported in a printing region to form an image, and an operation in which a plurality of heads move in a paper widthwise direction intersecting the transport direction, and then transports the continuous sheet in the transport direction.

### Regarding the Fluid Ejecting Apparatus

In the above-described embodiment, the ink jet printer is illustrated as the fluid ejecting apparatus, but it is not limited thereto. It can be applied to various industrial apparatuses as a fluid ejecting apparatus, in addition to a printer (printing apparatus). For example, the invention can be applied to, for example, a printing apparatus for transferring a pattern on clothes, a display fabricating apparatus, such as a color-filter fabricating apparatus or an organic EL fabricating apparatus, a DNA chip fabricating apparatus for fabricating a DNA chip by applying a solution dissolved with DNA on a chip. Further, it is not limited to the ejection of liquid, and, for example, it may be applied to an apparatus for ejecting a fluid such as particles.

Further, the method for ejecting the fluid includes a piezoelectric method for ejecting the fluid by applying a voltage to a driving element (a piezoelectric element) to expand and contract an ink chamber, and a thermal method for ejecting the fluid by generating bubbles in the nozzles using a thermal element.

What is claimed is:

1. A method for correcting pixel data in a fluid ejecting apparatus which relatively moves a nozzle array having nozzles for ejecting a fluid onto a medium and arranged in parallel in a predetermined direction, and the medium in a direction intersecting the predetermined direction, onto which the fluid is ejected from the nozzle array based on pixel data of the first number of gradations, while the nozzle array and the medium are relatively moved in the intersecting direction, the method comprising:
converting original pixel data of the first number of gradations into pixel data of the second number of gradations higher than the first number of gradations;
correcting the pixel data of the second number of gradations, of which the number of gradations is converted, by a correction value set for every pixel line data which is the plurality of pixel data lined up in a direction corresponding to the intersecting direction on the pixel data; and
converting the pixel data of the second number of gradations which is corrected by the correction value into the pixel data of the first number of gradations.

2. The method for correcting pixel data according to claim 1, further comprising, in the original pixel data of second number of gradations, of which the number of gradations is converted from the original pixel data of the first number of gradations,
distributing a gradation value expressed by the selected original pixel data among the original pixel data of the second number of gradations to the selected original pixel data and the original pixel data adjacent to the selected original pixel data to calculate averaged pixel data of the second number of gradations;
determining a correction value corresponding to the averaged pixel data of the second number of gradations; and
correcting the original pixel data of the second number of gradations by the determined correction value.

3. The method for correcting pixel data according to claim 1, further comprising, in the original pixel data of second number of gradations, of which the number of gradations is converted from the original pixel data of the first number of gradations,
distributing a gradation value expressed by the selected original pixel data among the original pixel data of the second number of gradations to the selected original pixel data and the original pixel data adjacent to the selected original pixel data to calculate averaged pixel data of the second number of gradations;
determining a correction value corresponding to the averaged pixel data of the second number of gradations; and
correcting the averaged pixel data of the second number of gradations by the determined correction value.

4. The method for correcting pixel data according to claim 2, wherein the correction value is set for a plurality of gradation values in the second number of gradations.

5. The method for correcting pixel data according to claim 2, wherein when the gradation value expressed by the selected original pixel data of the second number of gradations is distributed to the selected original pixel data and the original pixel data adjacent to the selected original pixel data, the gradation values which are distributed to the original pixel data spaced apart from the selected original pixel data at first distance are more than the gradation values which are distributed to the original pixel data spaced apart from the selected original pixel data at a second distance which is longer than the first distance.

6. The method for correcting pixel data according to claim 1, wherein the correction value corresponding to the original pixel data of the second number of gradations, of which the number of gradations is converted from the original pixel data of the first number of gradations, is determined, and
the original pixel data of the second number of gradations is corrected by the determined correction value.

7. The method for correcting pixel data according to claim 1, when the pixel data of the second number of gradations which is corrected by the correction value is converted into the pixel data of the first number of gradations,
a value related to a formation rate of dots corresponding to the gradation value expressed by the selected pixel data among the pixel data of the second number of corrected gradations is compared with a threshold value to determine existence of dot formation in the selected pixel data; and
a difference between the value related to the formation rate of the dots and the threshold value is distributed to the pixel data adjacent to the selected pixel data.

8. A fluid ejecting apparatus comprising:
(A) a nozzle array having nozzles for ejecting a fluid onto a medium and arranged in parallel in a predetermined direction;
(B) a moving mechanism relatively moving the nozzle array and the medium in a direction intersecting the predetermined direction; and
(C) a control unit that ejects the fluid from the nozzle array based on pixel data of the first number of gradations, while the nozzle array and the medium are relatively moved in the intersecting direction by the moving mechanism,
wherein original pixel data of the first number of gradations are converted into pixel data of the second number of gradations higher than the first number of gradations; the pixel data of the second number of gradations, of which the number of gradations is converted, are corrected by a correction value set for every pixel line data which is the plurality of pixel data lined up in a direction corresponding to the intersecting direction on the pixel data; and
the pixel data of the second number of gradations which are corrected by the correction value is converted into the pixel data of the first number of gradations.
